(19) United States
(12) Patent Application Publication
(10) Pub. No.: US 2007/0200841 A1
(43) Pub. Date: Aug. 30, 2007

(54) Information processing apparatus and imaging control method

(76) Inventor: Masaya Sahashi, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/700,560

(22) Filed: Jan. 31, 2007

(30) Foreign Application Priority Data
Jan. 31, 2006 (JP) 2006-023405

(51) Int. Cl. G09G 5/00

(52) U.S. Cl. 345/204

(57) ABSTRACT

According to one embodiment, an information processing apparatus, includes a body, a display unit which is supported by the body and which is rotatable between the closed position at which it covers the upper surface of the body and the open position at which it is raised up to expose the upper surface of the body, a display controller which generates a video signal, and an operating system which stops sending an imaging request to a driver that controls the display controller when the display unit is positioned at the closed position.

### CROSS-REFERENCE TO RELATED APPLICATIONS

This application is based upon and claims the benefit of priority from Japanese Patent Application No. 2006-023405, filed Jan. 31, 2006, the entire contents of which are incorporated herein by reference.

### BACKGROUND

1. Field

One embodiment of the invention relates to an information processing apparatus having a display unit and an imaging control method applied to the information processing apparatus.

2. Description of the Related Art

In recent years, various battery driven personal computers (PCs) designed for portable or mobile use have been developed. Among such type of battery driven PCs, we can use a portable electronic device such as a notebook in an outdoor environment by utilizing a built-in battery. In such type of PCs, various techniques have been applied to extend battery life.

For example, Jpn. Pat. Appln. Publication No. 2003-223246 discloses a method in which when a display panel is closed, an LCD backlight is turned off, an output of a video signal from a graphics controller to an LCD is stopped, and a power supply to the LCD display panel is stopped to reduce power consumption.

However, in the above technique, although an output of a video signal from a graphics controller to an LCD is stopped, the graphics controller is still performing calculation for generating a video signal. To generate a video signal in a state where the video signal cannot be output to the LCD is a waste of power consumption.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an example of a personal computer (PC) serving as an information processing apparatus according to an embodiment of the present invention;

FIG. 2 is an exemplary block diagram showing an example of a circuit configuration of the PC according to the embodiment of the present invention;

FIG. 3 is an exemplary view showing an example of a window for a user to set whether an imaging request is transferred when a display unit is positioned at a closed state;

FIG. 4 is an exemplary block diagram showing a configuration for preventing the imaging request from being transferred to a graphics controller when the display unit is positioned at a closed state;

FIG. 5 is an exemplary flowchart showing the procedure of processing for preventing the imaging request from being transferred to a graphics controller when the display unit is positioned at a closed state; and

FIG. 6 is an exemplary flowchart showing the procedure of processing for determining whether the graphics controller is outputting a video signal to an external display apparatus.

### DETAILED DESCRIPTION

Various embodiments according to the invention will be described hereinafter with reference to the accompanying drawings. In general, according to one embodiment of the invention, an information processing apparatus, comprises a body, a display unit which is supported by the body and which is rotatable between the closed position at which it covers the upper surface of the body and the open position at which it is raised up to expose the upper surface of the body a display controller which generates a video signal, and an operating system which stops sending an imaging request to a driver that controls the display controller when the display unit is positioned at the closed position.

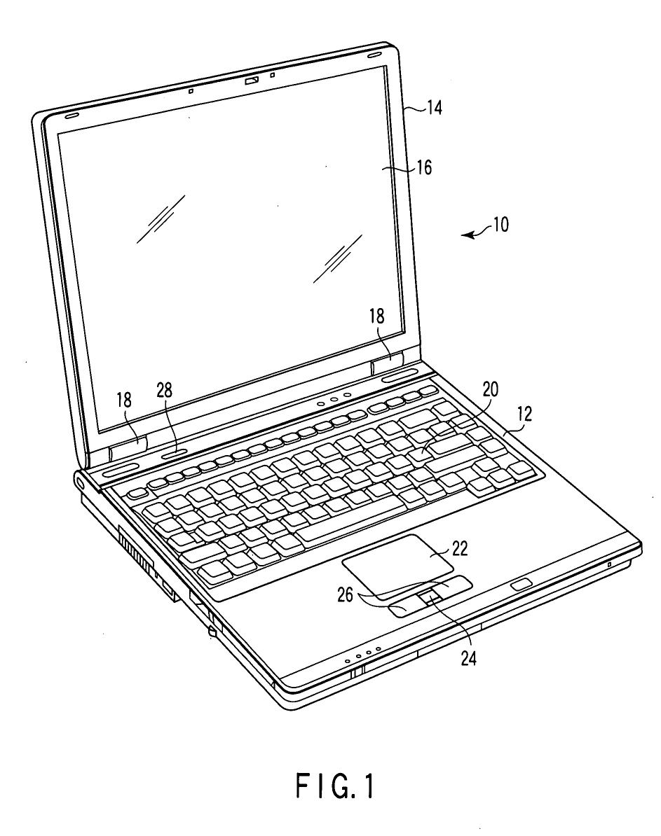

FIG. 1 is a view showing an example of a configuration of a notebook type PC serving as an information processing apparatus according to an embodiment of the present invention.

A PC 10 includes a computer main body 12 and a display unit 14 serving as a display means. An LCD (Liquid Crystal Display) 16 serving as a display panel is incorporated in the display unit 14.

The display unit 14 is attached to hinges (supporting portion) 18 provided on the depth-side end of the computer main body 12 so as to be pivotable between the closed position at which the display unit 14 covers the upper surface of the computer main body 12 and open position at which the display unit is raised up to expose the upper surface of the computer main body 12.

The computer main body 12 has a thin box-shaped casing, and the casing has, at the center portion on its upper surface, a keyboard 20. A palm rest is formed at the computer front-side portion on the casing upper surface. A touch pad 22, a scroll button 24, and touch pad control buttons 26 are provided on almost the center area of the palm rest. A power button 28 for turning ON/OFF a power supply to the computer main body 12 is provided at the computer depth-side portion on the casing upper surface.

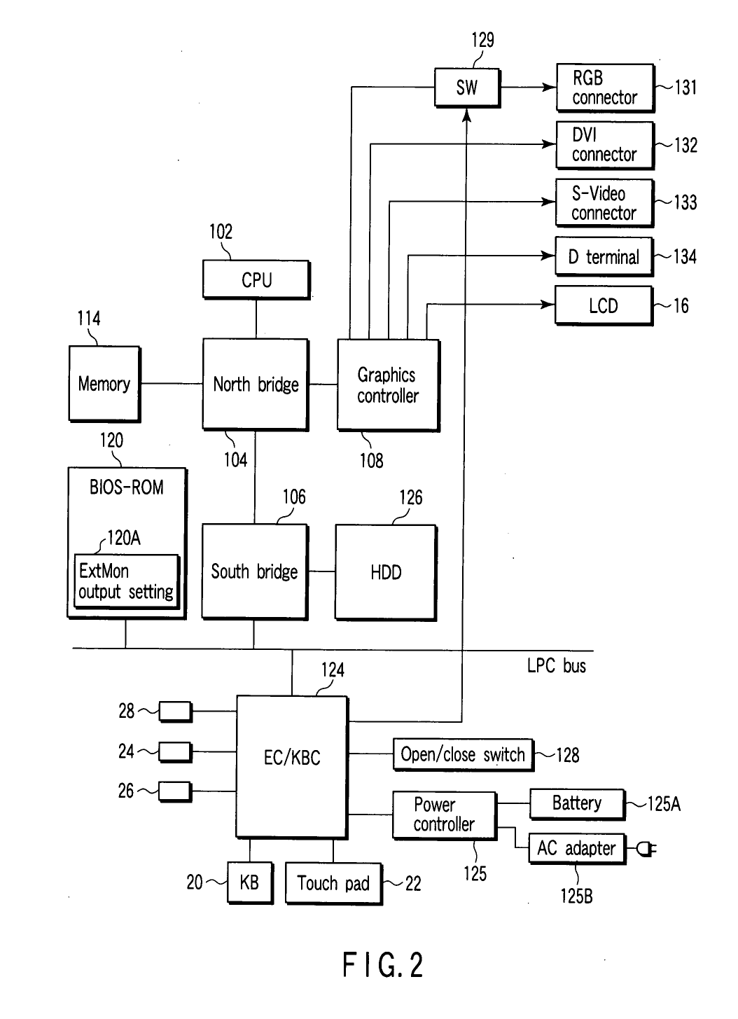

Referring to FIG. 2, an example of a system configuration of the PC 10 will be described.

As shown in FIG. 2, the PC 10 includes a CPU 102, a north bridge 104, a main memory 114, a graphics controller 108 serving as an output means, a south bridge 106, a BIOS-ROM 120, a hard disk drive (HDD) 126, an embedded controller/keyboard controller IC (EC/KBC) 124, a power controller 125, an open/close switch 128, and the like.

The CPU 102 is a processor provided for controlling the operation of the PC 10 and executes an operating system (OS) and various application programs loaded from the HDD 126 to the main memory 114.

The CPU 102 further loads a system BIOS (Basic Input Output System) and VGA BIOS (Video Graphics Array Basic Input Output System) stored in the BIOS-ROM 120 to the main memory 114 and executes them. The system BIOS is a program for controlling hardware.

The north bridge 104 is a bridge device connecting a local bus of the CPU 102 and the south bridge 106. The north bridge 104 incorporates a memory controller that controls the access to the main memory 114. The north bridge 104 has also a function of communicating with the graphics controller 108 via an AGP (Accelerated Graphics Port) bus.

The graphics controller 108 is a display controller that controls the LCD 16 used as a display monitor of the PC 10. The graphics controller 108 includes a video memory (VRAM). The graphics controller 108 generates a video signal for forming a display image to be displayed on the LCD 16 from display data written to the video memory (VRAM) by the OS/application program. The video signal generated by the graphics controller 108 is output to a line.

Further, the graphics controller 108 can output the video signal to an external display apparatus connected thereto via an RGB connector 131, a DVI connector 132, an S-Video connector 133, or a D terminal 134. A setting whether to output a video signal to the external display apparatus connected to the graphics controller 108 via the RGB connector 131, DVI connector 132, S-Video connector 133, or D terminal 134 is registered in an ExtMon output setting 120A on the BIOS-ROM 120. A switch 129 is provided between the RGB connector 131 and the graphics controller 108, thereby controlling ON/OFF of video signal output. Further, the video signal output from the graphics controller 108 to the DVI connector 132, S-Video connector 133, or D terminal 134 can be controlled by a command from a video BIOS.

The EC/KBC 124 controls the touch pad 22, scroll button 24, and touch pad control buttons 26 which serve as an input means. The EC/KBC 124 is a single-chip microcomputer that monitors and controls various devices (peripheral devices, sensors, or power circuits) irrespective of the system state of the PC 10.

In the case where an external power source is supplied via an AC adapter 125B, the power controller 125 uses the external power source to generate a system power source to be supplied to respective components of the PC 10. Otherwise, the power controller 125 uses a battery 125A to generate a system power source to be supplied to respective components (computer main body 12 and display unit 14) of the PC 10.

The open/close switch 128 is provided as an open/close state detection section for detecting whether the display unit 14 is positioned at the closed position. A detection result of the open/close switch 128 is supplied to the EC/KBC 124. In the case where the display unit 14 is positioned at the closed position, the EC/KBC 124 controls the power controller 125 not to supply a system power to the LCD 16.

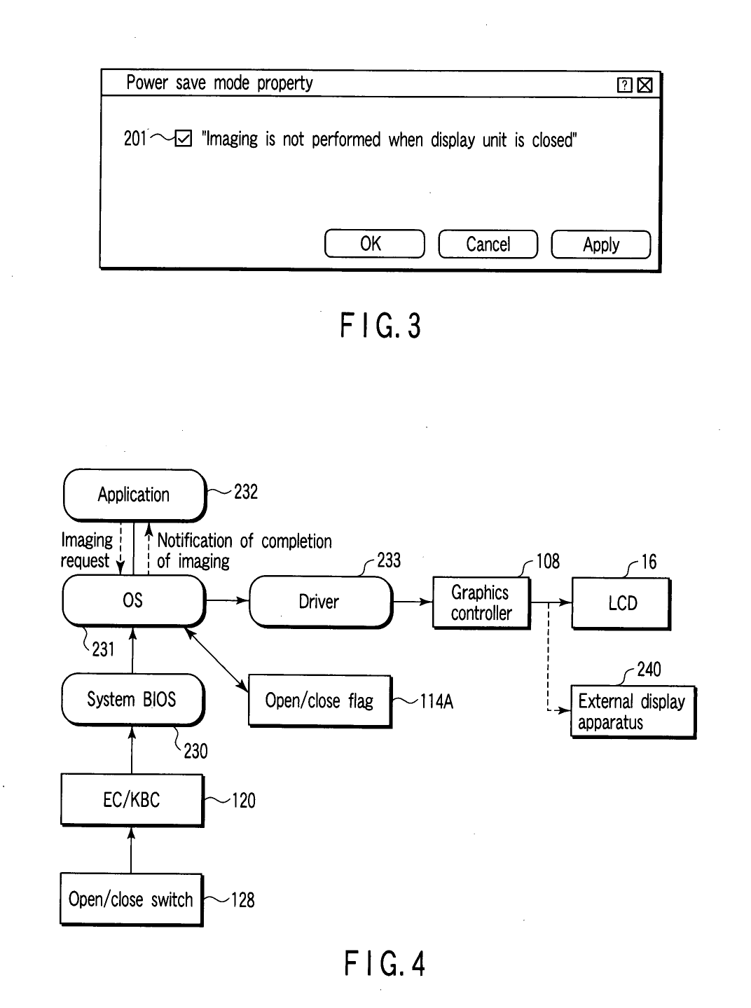

In the PC 10 according to the present embodiment, if a user adds a check mark to a check box 201 saying “Imaging is not performed when display unit is closed” as shown in FIG. 3, the OS/application program does not issue an imaging command to the graphics controller 108 when the display unit 14 is positioned at the closed position, so that the graphics controller 108 does not generate a video signal for forming a display image to be displayed on the LCD 16.

That is, the graphics controller 108 enters a standby state, thus reducing power consumption.

Next, a configuration for keeping the graphics controller 108 from generating a video signal will be described with reference to FIG. 4.

As shown in FIG. 4, the open/close switch 128 detects whether the display unit 14 is positioned at the open position or closed position. A detection result of the open/close switch 128 is sent to the EC/KBC 124. When the detection result of the open/close switch 128 is changed during or after the start-up time, the EC/KBC 124 notifies the system BIOS 230 of the detection result in an interrupted manner. Then, the system BIOS 230 notifies an operating system 231 serving as a control means of the detection result of the open/close switch 128. The operating system 231 writes the detection result of the open/close switch 128 in an open/close flag 114A on the memory 114. For example, the operating system 231 writes “1” when the display unit 14 is positioned at the open position while writes “0” when the display unit 14 is positioned at the closed position. Further, the operating system 231 determines whether the graphics controller 108 is outputting a video signal to an external display apparatus 240.

In the case where the display unit 14 is positioned at the closed position and the graphics controller 108 is not outputting a video signal to the external display apparatus 240, although the operating system 231 does not issue an imaging command to a driver 233 even if an application 232 serving as a means for issuing an imaging request issues the imaging request to the operating system 231, it returns to the application 232 information notifying that the imaging processing has normally been performed.

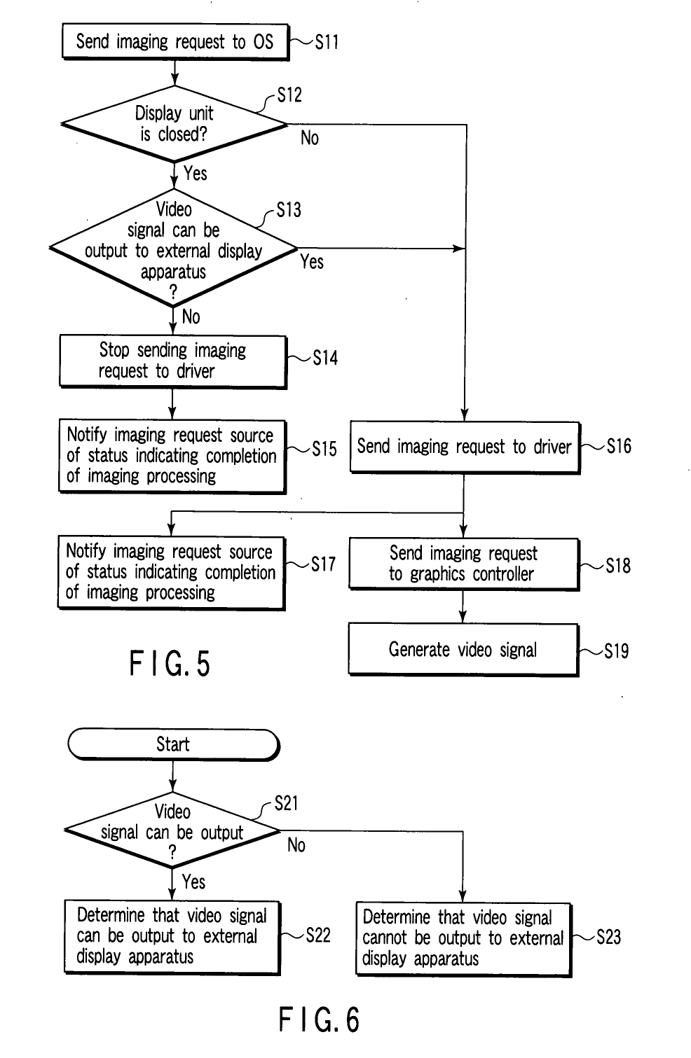

Next, processing performed in the case where the a check mark is added to the check box 201 to prevent the imaging from being performed when the display unit 14 is closed will be described with reference to the flowchart of FIG. 5.

Firstly, the application 232 sends an imaging request to the operating system 231 (block S11). Upon receiving the imaging request, the operating system 231 refers to the open/close flag 114A to determine whether the display unit 14 is positioned at the closed position (block S12).

In the case where the display unit 14 is positioned at the closed position, the operating system 231 determines whether the current setting allows a video signal to be supplied from the graphics controller 108 to an external display apparatus (block S13). The procedure of processing for determining whether the current setting allows a video signal to be supplied to an external display apparatus will be described with reference to FIG. 6.

The operating system 231 refers to the ExtMon output setting 120A to determine whether the current setting allows a video signal to be supplied to an external display apparatus (block S21). In the case where the current setting allows a video signal to be supplied to an external display apparatus (Yes in block S21), the operating system 231 determines that a video signal can be supplied to an external display apparatus (block S22). In the case where the current setting does not allow a video signal to be supplied to an external display apparatus (No in block S21), the operating system 231 determines that a video signal cannot be supplied to an external display apparatus (block S23).

In the case where the current setting does not allow a video signal to be supplied to an external display apparatus (No in block S13), the operating system 231 stops sending an imaging request to the driver 233 (block S14). Then, the operating system 231 notifies the application 232 of status information indicating that the imaging processing has normally been performed (block S15).

In the case where the display unit 14 is not positioned at the closed position (No in block S12) or where the current setting allows a video signal to be supplied from the graphics controller 108 to an external display apparatus (Yes in block S13), the operating system 231 sends an imaging request to the driver 233 (block S16). After that, the operating system 231 notifies the application 232 of the status information indicating that the imaging processing has normally been performed (block S17).

The driver 233 sends the imaging request that has been received from the operating system 231 to the graphics controller 108 (block S18). The graphics controller 108 generates a video signal based on the imaging request (block S19).

The above processing prevents the imaging request from automatically being sent to the graphics controller 108 when the display unit 14 is positioned at the closed position. In this case, the graphics controller 108 does not receive the imaging request, so that it does not perform calculation for generating a video signal, thereby achieving power saving.

Further, the operating system 231 notifies the application 232 of the status information indicating that the imaging processing has normally been performed even though it does not issue the imaging request to the driver 233, so that the application 232 determines that the imaging processing has normally been completed. If the application 232 has not received the status information indicating that the imaging processing has normally been performed, it determines that the imaging processing has not normally been completed and performs error processing. However, since the application 232 has received the status information indicating that the imaging processing has normally been performed, an intended result can be obtained.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a body;
a display unit which is supported by the body and which is rotatable between the closed position at which it covers the upper surface of the body and the open position at which it is raised up to expose the upper surface of the body;
a display controller which generates a video signal; and
an operating system which stops sending an imaging request to a driver that controls the display controller when the display unit is positioned at the closed position.

2. The information processing apparatus according to claim 1, wherein
the display controller is capable of supplying the generated video signal to an external display apparatus connectable to the body, and
the operating system stops sending the imaging request when the display unit is positioned at the closed position and the generated video signal cannot be output from the display controller to the external display apparatus.

3. The information processing apparatus according to claim 1, further comprising setting unit which sets whether the imaging request is sent from the operating system to the driver, when the display unit is positioned at the closed position with respect to the body.

4. The information processing apparatus according to claim 1, further comprising an application which sends an imaging request to the operating system, wherein
when receiving the imaging request sent from the application, the operating system stops sending the imaging request to the driver and, at the same time, sends status information indicating that imaging processing has normally been performed to the application.

5. An information processing apparatus comprising:
a body;
a display unit which is supported by the body and which is rotatable between the closed position at which it covers the upper surface of the body and the open position at which it is raised up to expose the upper surface of the body;
a display controller which generates a video signal;
a driver which controls the display controller;
an operating system which stops sending an imaging request to the driver in the case where the display unit is positioned at the closed position with respect to the body; and
an application which sends an imaging request to the operating system and which determines that imaging processing has normally been performed, when the operating system stops sending the imaging request to the driver in a state where the display unit is positioned at the closed position with respect to the body.

6. The information processing apparatus according to claim 5, wherein
the display controller is a controller that can supply the generated video signal to an external display apparatus connectable to the body, and
the operating system stops sending the imaging request when the display unit is positioned at the closed position with respect to the body and where the generated video signal can be output from the display controller to the external display apparatus.

7. The information processing apparatus according to claim 5, further comprising setting section which sets whether the imaging request is sent from the operating system to the driver in the case where the display unit is positioned at the closed position with respect to the body.

8. An imaging control method applied to an information processing apparatus including a body, a display unit which is supported by the body and which can be pivoted between the closed position at which it covers the upper surface of the body and the open position at which it is raised up to expose the upper surface of the body and a display controller which generates a video signal, the method comprising:
determining whether the display unit is positioned at the closed position with respect to the body; and
stopping sending of an imaging request from an operating system to a driver that controls the display controller in the case where the display unit is positioned at the closed position with respect to the body.

9. The imaging control method according to claim 8, wherein
the display controller is a controller that can supply the generated video signal to an external display apparatus connectable to the body, and
the operating system stops sending the imaging request when the display unit is positioned at the closed position with respect to the body and where the generated video signal cannot be output from the display controller to external display apparatus.

10. The imaging control method according to claim 8, wherein
the information processing apparatus further comprises setting unit for setting whether the imaging request is sent from the operating system to the driver in the case where the display unit is positioned at the closed position with respect to the body, and
the imaging request is not sent from the operating system to the driver, when the setting unit makes a setting such that the imaging request is prevented from being sent from the operating system to the driver and where the display unit is positioned at the closed position with respect to the body.

11. The imaging control method according to claim 8, wherein
the information processing apparatus further comprises an application which sends an imaging request to the operating system, and
when receiving the imaging request sent from the application, the operating system stops sending the imaging request to the driver and, at the same time, sends status information indicating that imaging has normally been performed to the application.
